(19) United States
(12) Patent Application Publication
(10) Pub. No.: US 2001/0006057 A1
(43) Pub. Date: Jul. 5, 2001

(54) Method and system for variably controlling exhaust pressure of diesel engine

(76) Inventor: Buom-Sik Shin, Seoul (KR)

Correspondence Address: CHRISTIE, PARKER & HALE, LLP, 350 WEST COLORADO BOULEVARD, SUITE 500, PASADENA, CA, 91105, US

(21) Appl. No.: 09/752,617

(22) Filed: Dec. 28, 2000

(30) Foreign Application Priority Data
Dec. 28, 1999 (KR) 1999-63692

(51) Int. Cl. F02D 9/04; F02M 25/07; F02B 47/08

(52) U.S. Cl. 123/323; 60/324; 123/568.14

(57) ABSTRACT

An exhaust pressure control system for a diesel engine includes a device for adjusting exhaust pressure of gas exhausted from an exhaust manifold, and an engine control unit for controlling the device according to an engine operation state. The device includes a rotational valve for opening and closing the exhaust pipe , a motor for rotating the rotational valve according to a signal from the engine control unit, and an encoder for detecting an opening state of the exhaust pipe and transmitting a corresponding signal to the engine control unit.

### BACKGROUND OF THE INVENTION

(a) Field of the Invention

The present invention relates to a method and system for controlling exhaust pressure of a diesel engine, and more particularly, to a method and device that can improve a cool start, a fuel consumption, and engine output performance by variably controlling exhaust gas pressure in a diesel engine.

(b) Description of the Related Art

Generally, exhaust gas generated in a diesel engine is exhausted through an exhaust manifold. In a conventional technology, exhaust gas pressure is not controlled. Some advanced system is ,at the higher cost, introduced to control exhaust gas pressure by disposing a sensor detecting the pressure of the exhaust gas at an exhaust gas outlet and controlling the opening of the outlet valve according to a signal from the sensor.

In a conventional diesel engine exhaust gas pressure is dependent upon engine operating condition. Exhaust pressure is high under high speed and high load dut to the increase of flow rate. As engine load and speed are reduced flow rate decreases, which results in low exhaust pressure. Engine output power is, under the high speed condition, reduced with the increase of exhaust gas pressure. Pumping loss which occurs during gas exchage process have a great influnce on the rated power reduction. On the other hand, pumping loss is negligible at the low speed and load operation. Exhaust gas can be used to improve the auto ignition by raising exhaust gas pressure to augment the residual gas fraction in a combuston chamber. Currtly, exhaust gas pressure can not be controlled into optimum in most of the current diesel engines because they are not equipped with economical devices and method for controlling exhaust gas pressure. If the pressure transducer is additionally installed to control exhaust gas pressure, extra cost would be counted.

For the above reason, the technology has been no longer applied to the diesel engine, as a result of which the engine performance is not still optimally obtained.

### SUMMARY OF THE INVENTION

Therefore, there is a need for a variable exhaust pressure control method and system that can control the amount of the exhaust gas according to driving conditions of a diesel engine vehicle, thereby improving the engine performance.

To meet the above need, the present invention provides an exhaust pressure control system for a diesel engine, comprising means for adjusting exhaust pressure of gas exhausted from an exhaust manifold; and an engine control unit for controlling the means for adjusting according to an engine operation state.

Preferably, the means for adjusting comprises a rotational valve for opening and closing the exhaust manifold, a motor for rotating the rotational valve according to a signal from the engine control unit, and an encoder for detecting an opening state of the exhaust manifold and transmitting a corresponding signal to the engine control unit.

The rotational valve is provided with a hole for preventing the exhaust pipe from being sealed.

According to another aspect, the present invention provides a method for controlling exhaust pressure of a diesel engine, comprising the steps of to detecting an engine operation state; calculating an exhaust pressure according to the detecting result; determining if the calculated exhaust pressure is an optimum exhaust pressure; and adjusting an exhaust pressure adjusting device according to the determined result.

The step of adjusting an exhaust pressure further comprises the steps of operating the exhaust pressure adjusting device to adjust opening of the pipe when the calculated exhaust pressure is not the optimum exhaust pressure, and determining if there is a variation in an engine operation.

The step of adjusting an exhaust pressure further comprises the step of maintaining a current operating state of the exhaust pressure adjusting device when the calculated exhaust pressure is the optimum exhaust pressure.

The calculation of the exhaust pressure is performed according to current air and fuel amounts.

### BRIEF DESCRIPTION OF THE DRAWINGS

The accompanying drawings, which are incorporated in and constitute a part of the specification, illustrate an embodiment of the invention, and, together with the description, serve to explain the principles of the invention:

FIG. 1 is a schematic diagram for illustrating a variable exhaust pressure control system for a diesel engine;

FIG. 2 is a flowchart illustrating a method for variably controlling exhaust pressure for a diesel engine according to a preferred embodiment of the present invention;

FIG. 3 is an enlarged view illustrating an exhaust pressure adjusting device according to a preferred embodiment of the present invention;

FIG. 4a is graphs illustrating the improvement in fuel consumption by increasing exhaust pressure at a low engine speed according to the present invention; and

FIG. 4b is graphs illustrating the improvement in fuel consumption by reducing exhaust pressure at a high engine speed according to the present invention.

### DETAILED DESCRIPTION OF THE PREFERRED EMBODIMENTS

A preferred embodiment of the present invention will be described hereinafter with reference to the accompanying drawings.

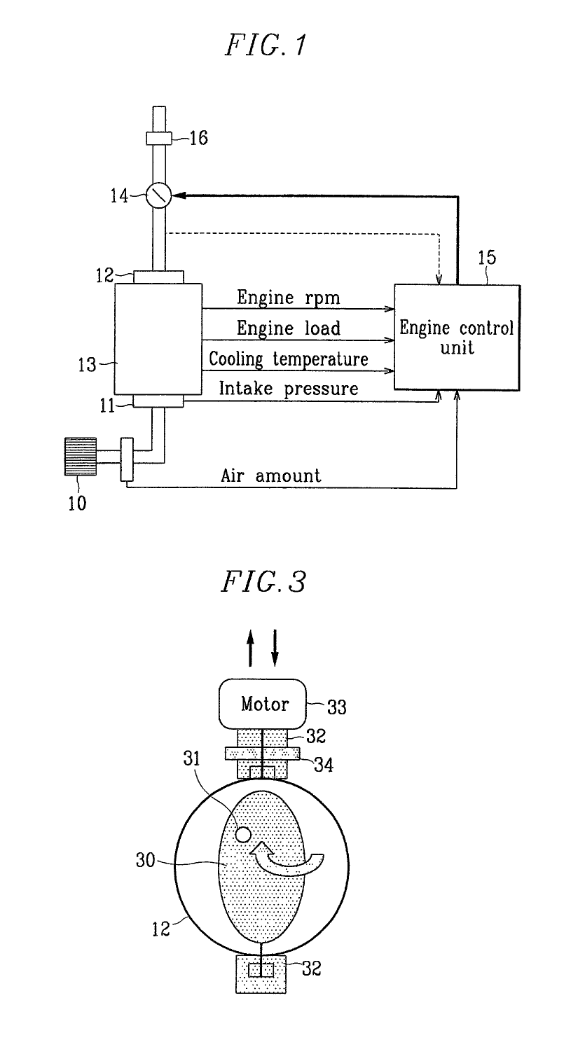

FIG. 1 shows a block diagram illustrating a variable exhaust pressure control system for a diesel engine.

As shown in the drawing, the inventive system comprises an exhaust pressure adjusting device 14 for adjusting exhaust pressure from an exhaust pipe 12 mounted on an outlet side of an engine 13 and an engine control unit 15 for controlling the exhaust pressure adjusting device 14 according to an engine condition. An air filter 10 and an intake manifold 11 are mounted on an air inlet side of the engine 13.

A variety of sensors (not shown) are associated with the engine 13, and according to signals regarding engine speed, engine load, temperature of cooling water, intake pressure, and amount of intake air, the engine control unit 15 determines the engine condition.

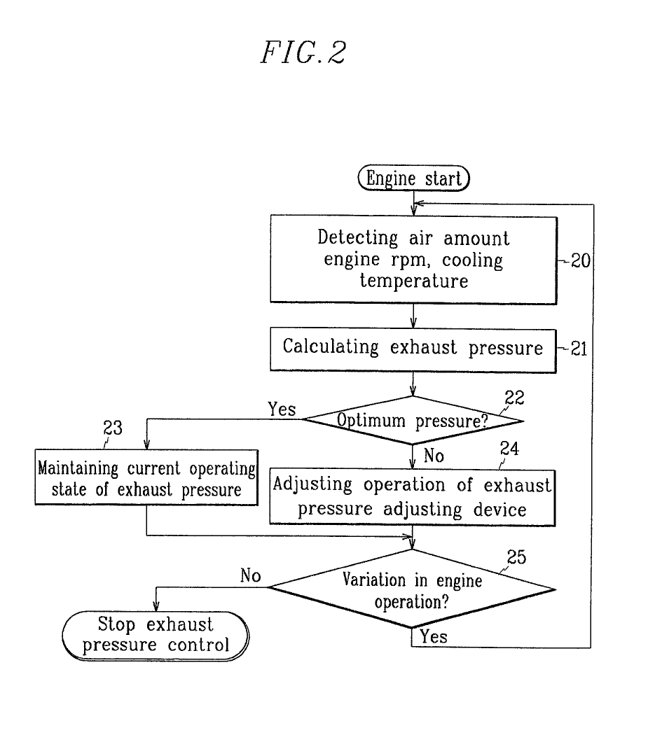

FIG. 2 shows a flowchart illustrating a method for variably controlling the exhaust pressure using the above described variable exhaust pressure control system.

First, the engine control unit detects the air amount, the fuel amount, the engine speed(rpm), the engine load, and a temperature of cooling water from the variety of sensors (S20), and then calculates exhaust pressure according to the detected air and fuel amounts (S21). The engine control unit determines if the calculated exhaust pressure is an optimal exhaust pressure with respect to the engine rpm, the engine load and the temperature of cooling water (S22).

When the calculated exhaust pressure is the optimal exhaust pressure, the engine control unit controls the exhaust pressure adjusting device to keep the current state (S23). When the calculated exhaust pressure is not the optimal exhaust pressure, the engine control unit controls the opening of the exhaust pressure adjusting device such that the exhaust pressure becomes optimal (S24), then determines if the engine operation is varied (S25).

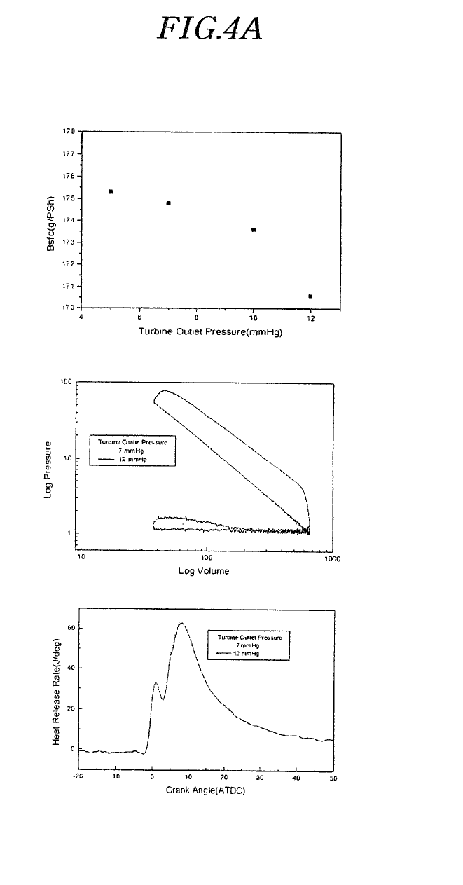

FIG. 3 shows an enlarged view of the exhaust pressure adjusting device of the present invention.

The exhaust pressure adjusting device 14 of the present invention includes a rotational valve 30 for opening/closing the exhaust pipe 12, a sealing prevention hole 31 for preventing the exhaust manifold from being sealed, a bearing part 32 for supporting upper and lower portions of the rotational valve 30, a motor 33 for rotating the rotational valve 30 to open and close the rotational valve 30, an encoder 34 for outputting signals regarding the opening/closing state of the rotational valve 30 to the electronic control unit.

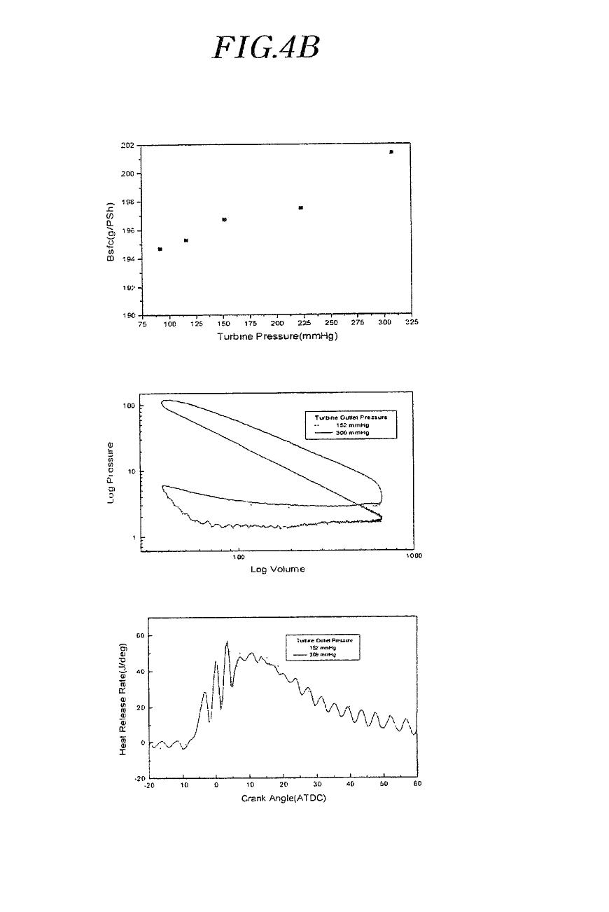

FIG. 4a shows graphs illustrating a brake specific fuel consumption (Bsfc), a log pressure, and a heat release rate at 1000 rpm and an engine full load when the exhaust pressure is increased, and FIG. 4b shows graphs illustrating a brake specific fuel consumption (Bsfc), a log pressure, and a heat release rat at 4000 rpm and an engine full load when the exhaust pressure is reduced.

As described above, when the engine operates, fuel is burned into exhaust gas. Air used to burn the fuel is in-taken through the air filter 10, then supplied to the engine 13 through the intake manifold 11, and exhausted through the exhaust pipe.

While the burned gas is exhausted, the engine control unit 15 detects values on the air amount, the fuel amount, the engine load, the engine speed(rpm), and the temperature of cooling water (S20).

In step 21, the engine control unit 15 calculates an exhaust pressure (P) using a following preset algorithm according to the detected values. At this point, the exhaust pressure (P) is calculated according to the following equation

P=MP*(CA+CF)²/(MA+MF)²

Where, MP, MA and MF are exhaust pressure, an amount of air, and an amount of fuel at the maximum power point, respectively, which are preset in the engine control unit as constants.

The calculated exhaust pressure is compared with a standard value preset in the engine control unit, then it is determined if the calculated exhaust pressure is the optimum exhaust pressure (S22).

When the calculated exhaust pressure is the optimum exhaust pressure, the engine control unit 15 does not operate the motor 33 of the exhaust pressure adjusting device 14 to maintain the current opening state (S23).

However, when the calculated exhaust pressure is not the optimum exhaust pressure, the engine control unit 15 controls the motor 33 such that the rotational valve 30 rotates to adjust opening of the exhaust manifold 12. At this point, as shown in FIG. 4a, when the engine rpm is around 1000 rpm at a full load, the rotational valve 30 rotates in a direction where the exhaust manifold 12 is closed to increase the exhaust pressure, thereby improving the fuel consumption and the cold I start performance by heating the engine using residual combustion heat. When the exhaust pressure is increased, although loss during the intake and exhaust processes is increased, since the engine speed(rpm) and the amount of fuel is low, the loss can be ignored (see a Log Pressure-Log Volume relationship graph in FIG. 4a ).

However, as shown in FIG. 4b, when the engine speed(rpm) is around 4000 rpm at full load, the engine control unit controls the motor 33 such that the rotational valve 30 rotates in a direction where the exhaust manifold 12 is opened to reduce the exhaust pressure, thereby improving the fuel consumption (S24). That is, since the temperature of the combustion chamber is sufficiently high, the increase of the exhaust pressure does not affect the improvement of the combustion efficiency, but the loss during the intake and exhaust gas exchange processes is increased (See the Log pressure-log Volume relationship graph in FIG. 4b ).

After adjusting the opening of the exhaust pipe according to the engine driving state, the engine control unit determines if there is a variation in the engine operation (S25)

When there is no variation in the engine operation, the exhaust pressure control is stopped, and there is a variation, the process is returned to the Step 20.

As described above, since the exhaust pressure is controlled according to the engine operation state, the fuel consumption and engine output power can be improved after the engine warm-up, especially the engine start can be smoothly realized by using residual heat during a cool start, thereby reducing emissions.

While this invention has been described in connection with what is presently considered to be the most practical and preferred embodiment, it is to be understood that the invention is not limited to the disclosed embodiments, but, on the contrary, is intended to cover various modifications and equivalent arrangements included within the spirit and scope of the appended claims.

What is claimed is:

1. An exhaust pressure control system for a diesel engine, comprising means for adjusting exhaust pressure of gas exhausted from an exhaust manifold; and
an engine control unit for controlling the means for adjusting according to an engine operation state.

2. The exhaust pressure control system of claim 1 wherein the means for adjusting comprises a rotational valve for opening and closing the exhaust pipe, a motor for rotating the rotational valve according to a signal from the engine control unit, and an encoder for detecting an opening state of the exhaust pipe and transmitting a corresponding signal to the engine control unit.

3. The exhaust pressure control system of claim 1 wherein the rotational valve is provided with a hole for preventing the exhaust manifold from being sealed.

4. A method for controlling exhaust pressure of a diesel engine, comprising the steps of:
detecting an engine operation state;
calculating an exhaust pressure according to the detecting result;
determining if the calculated exhaust pressure is an optimum exhaust pressure; and
adjusting an exhaust pressure adjusting device according to the determined result.

5. The method of claim 4 wherein the step of adjusting an exhaust pressure further comprises the steps of operating the exhaust pressure adjusting device to adjust opening of the exhaust pipe when the calculated exhaust pressure is not the optimum exhaust pressure, and determining if there is a variation in an engine operation.

6. The method of claim 4 wherein the step of adjusting an exhaust pressure further comprises the step of maintaining a current operating state of the exhaust pressure adjusting device when the calculated exhaust pressure is the optimum exhaust pressure.

7. The method of claim 5 wherein the calculation of the exhaust pressure is performed, without any transducer for measuring exhaust gas pressure, according to current air and fuel amounts.
